(19) United States
(12) Patent Application Publication
(10) Pub. No.: US 2025/0061796 A1
(43) Pub. Date: Feb. 20, 2025

(54) A SMART DOORBELL WITH TEMPERATURE SENSOR

(71) Applicant: Ademco Inc., Golden Valley, MN (US)

(72) Inventors: Silver Yang, Shanghai (CN); Sandy Wu, Shanghai (CN); Lisa Wang, Shanghai (CN)

(73) Assignee: Ademco Inc., Golden Valley, MN (US)

(21) Appl. No.: 18/728,516

(22) PCT Filed: Jan. 14, 2022
(86) PCT No.: PCT/US2022/070202

§ 371 Date: Jul. 12, 2024

(51) Int. Cl. G08B 21/22; G08B 3/10

(52) U.S. Cl. CPC G08B 21/22; G08B 3/10

(57) ABSTRACT

A smart doorbell is provided. The doorbell may be connected to a remote device. The doorbell comprises a processor: a call button configured to output a first signal when the call button is actuated by a user; and a temperature sensor positioned with respect to the call button such that when the call button is actuated by a user, the temperature sensor is capable of taking temperature measurements on a part of the user's wrist facing the temperature sensor. In response to the call button being actuated by a user, the processor is configured to receive the first signal from the call button: command the temperature sensor to measure a temperature of a part of the user's wrist: compare the temperature measured by the temperature sensor to a predefined threshold temperature: output a second signal according to the comparison between the temperature measured by the temperature sensor and the predefined threshold; and transmit the first signal and the second signal to at least one remote device via the network.

### FIELD OF THE INVENTION

The present invention relates to a smart doorbell which is capable of checking a visitor's temperature.

### BACKGROUND OF THE INVENTION

Covid-19 virus brought people's attention to contagious (transmissible, communicable) diseases, such as diseases caused by bacteria or viruses. Preventing the spread of such bacteria or viruses has become a priority in multiple settings, such as households and office spaces. To this end, multiple measures have been introduced to detect a potentially infected person.

One of the accepted ways of detecting a potentially infected person is measuring the person's body temperature. Existing methods, however, either require a hand-held thermometer or an automated thermometer which scans the person's temperature from a distance, usually at their forehead.

The hand-held devices are generally more precise, but they are also cumbersome because they need to be operated by a user, and some people might find it distressing when the device is pointed at their forehead. The automated methods, on the other hand, tend to be less precise, because the temperature is measured from a distance. Those automated methods that are more precise either require a relatively big, complex device, or they require the person to present a specific body part to a specific sensor in a specific manner. Therefore, the precision may again be compromised, because the person may not understand what is required of them, or they may not comply with the requirements.

The present invention aims at mitigating those disadvantages, especially in an environment such as home or office, where more precise devices and methods used in hospitals or hospital-like settings are impractical.

### SUMMARY OF THE INVENTION

In the first aspect, the present invention provides a smart doorbell communicatively connectable to at least one remote device via a network, the smart doorbell comprising a processor; a call button configured to output a first signal when the call button is actuated by a user; and a temperature sensor positioned with respect to the call button such that when the call button is actuated by a user, the temperature sensor is capable of taking temperature measurements on a part of the user's wrist facing the temperature sensor; wherein in response to the call button being actuated by a user, the processor is configured to: receive the first signal from the call button; command the temperature sensor to measure a temperature of a part of the user's wrist; compare the temperature measured by the temperature sensor to a predefined threshold temperature; output a second signal according to the comparison between the temperature measured by the temperature sensor and the predefined threshold; and transmit the first signal and the second signal to at least one remote device via the network.

In the second aspect, the present invention provides a method of operating a smart doorbell communicatively connectable to at least one remote device via a network, the doorbell comprising: a processor; a call button configured to output a first signal when the call button is actuated by a user; and a temperature sensor positioned with respect to the call button such that when the call button is actuated by a user, the temperature sensor is capable of taking temperature measurements on a part of the user's wrist facing the temperature sensor; the method comprising the following steps executed by the processor: receiving, in response to the call button being actuated by a user, the first signal from the call button; commanding, in response to receiving the first signal, the temperature sensor to measure a temperature of a part of the user's wrist; comparing the temperature of the part of the visitor's wrist to a predefined threshold temperature; outputting a second signal according to the comparison between temperature measured by the temperature sensor and the predefined threshold; and transmitting the first signal and the second signal to the at least one remote device via the network.

In the third aspect, the present invention provides a method of installation of a smart doorbell of the first aspect, comprising placing the doorbell at a location such that the call button is positioned in the upper part of the doorbell and the temperature sensor is positioned in the lower part of the doorbell.

Various embodiments of the present invention are described in the dependent claims and in the following detailed description.

### BRIEF DESCRIPTION OF THE DRAWINGS

Specific embodiments of the present invention will now be described, by way of example only, with reference to the accompanying drawings in which:

FIG. 1 is a doorbell according to an embodiment of the present invention;

FIG. 2 is a doorbell according to an embodiment of the present invention;

FIG. 3 is a flowchart illustrating operation of a doorbell according to a present invention;

FIG. 4 is a diagram of a doorbell according to an embodiment of the present invention;

FIG. 5 is a flow chart of a method of operation of a doorbell according to an embodiment of the present invention;

FIG. 6 is a flow chart of a method of operation of a doorbell according to an embodiment of the present invention.

### DETAILED DESCRIPTION

In the following detailed description, specific embodiments of the present invention are described. This description serves as examples only and the described embodiments are not intended to be limiting. The elements of the below-described embodiments may be combined together to form new embodiments not described herein.

In the Figures, which are provided for illustration only, like numbers designate like elements.

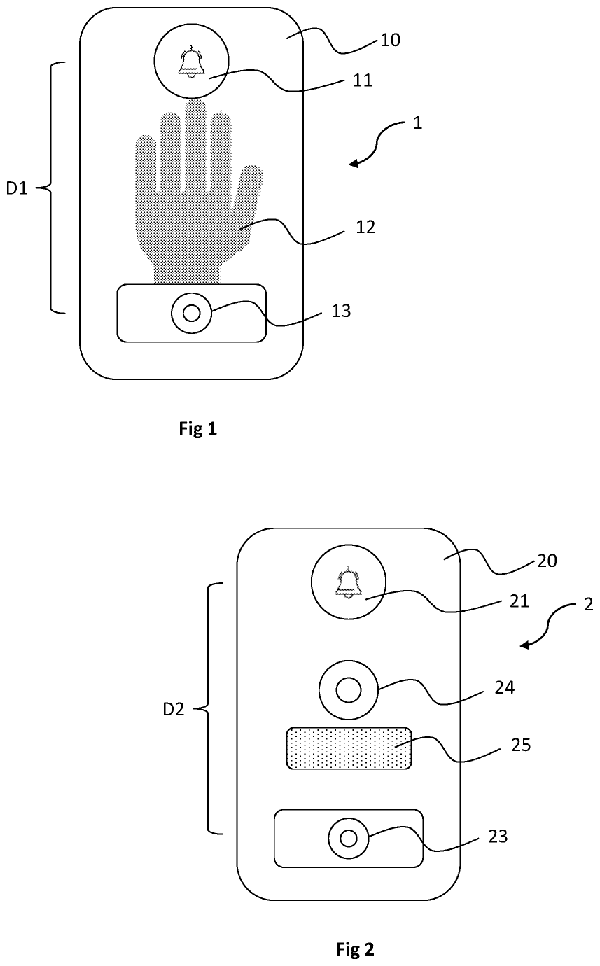

FIGS. 1 and 2 show a doorbell 1, 2 according to embodiments of the present invention. The doorbells 1, 2 may be positioned next to (in the vicinity of) a residential building door, a door of an office building, or other location through which visitors to a building have to pass to gain access to the building.

The doorbell 1 (of FIG. 1) comprises a housing 10. The housing 10 may be provided to house and/or protect the other components of the doorbell 10. The housing 10 may be made of plastic. The housing 10 may have a side which faces users (e.g. visitors) when the doorbell 1 is installed in its position at a door.

The doorbell 1 further comprises a call button 11. The call button 11 may be positioned adjacent to one of the edges of the housing 10. For example, the call button 11 may be positioned such that when the doorbell 1 is installed in position, the call button 11 is in the upper third of the housing 10. The call button 11 may be of any known type. For example, the call button 11 may be a push button. The call button 11 may be waterproof. The call button 11 may be coated in antibacterial or antiviral coating.

The doorbell 1 further comprises a temperature sensor 13. The temperature sensor 13 may be for example an IR sensor that is configured to measure a temperature of a human body. The temperature sensor 13 may be positioned adjacent to one of the edges of the housing 10. For example, the temperature sensor 13 may be positioned such that when the doorbell 1 is installed in position, the temperature sensor 13 is in the lower third of the housing 10.

In particular, when the doorbell 1 is installed in position, the call button 11 may be positioned in the upper part of the doorbell 1 and the temperature sensor 13 may be positioned in the lower part of the doorbell 1, and the call button 11 is above the temperature sensor 13. When the doorbell 1 is installed in position, the call button 11 may be positioned such that when a user actuates the call button 11 with their finger, their hand and lower arm is positioned such that the temperature sensor 13 is adjacent to the user's wrist.

As shown in FIG. 1, the call button 11 and the doorbell 13 are positioned such that there is a distance D1 between the call button 11 and the temperature sensor 13. The distance D1 may be measured e.g. between the centre of the call button 11 and the centre of the temperature sensor 13. The distance D1 may correspond to a distance between an average user's fingertip (e.g. a tip of index finger) and an average user's wrist (e.g. the point where a hand bends). The call button 11 and the temperature sensor 13 may be positioned relative to each other such that when a user actuates the call button 11, the user's wrist is positioned above or adjacent to the temperature sensor 13.

In an embodiment, the distance D1 may be between 5 and 25 cm. In an embodiment, the distance D1 may be between 8 and 20 cm. In an embodiment, the distance D1 may be between 10 and 16 cm. In some embodiments, the distance D1 may be 5 cm, 8 cm, 10 cm, 12 cm, 15 cm, 18 cm, 20 cm, 22 cm or 25 cm.

The housing 10 may further comprise a visual guide 12 to guide a user in putting their hand in the correct position. The visual guide 12 may be e.g. as shown in FIG. 1. The visual guide 12 may be provided in a shape of a hand, or in any other suitable shape (e.g. a shape of a finger, an arrow, or the like).

FIG. 2 shows an embodiment of a doorbell 2 comprising a housing 20, a call button 21 and a temperature sensor 23. The housing 20, the call button 21 and the temperature sensor 23 may be the same as the corresponding elements in the embodiment of FIG. 1. The distance D2 between the call button 21 and the temperature sensor 23 may be the same as or similar to the distance D1 described in connection with the embodiment of FIG. 1.

The doorbell 2 may further comprise a camera 24, a microphone/speaker 25, or both a camera and a microphone/speaker 25. The camera 24 may be provided to capture a user's image. The microphone/speaker 25 may be provided to facilitate communication between a user who actuated the call button 21 and a user inside of a building where the doorbell 2 is installed.

The camera 24, the microphone/speaker 25 and any other component, where provided, may be positioned as shown in FIG. 2, i.e. on the housing 20 between the call button 21 and the temperature sensor 23. Other positions of the camera 24, the microphone/speaker 25 and any additional components are possible as long as the distance D2 between the call button 21 and the temperature sensor 23 as well as the relative position of the call button 21 and the temperature sensor 23 are as described above in connection with FIG. 1.

When in use, the doorbell 2 may be positioned similarly to the doorbell 1 of FIG. 1. For example, the doorbell 2 may be positioned such that the call button 21 is in the upper part of the housing 20, the temperature sensor 23 is in the lower part of the housing, and the doorbell 2 is configured such that when a user actuates the call button 21, the user's wrist is positioned above or adjacent to the temperature sensor 23.

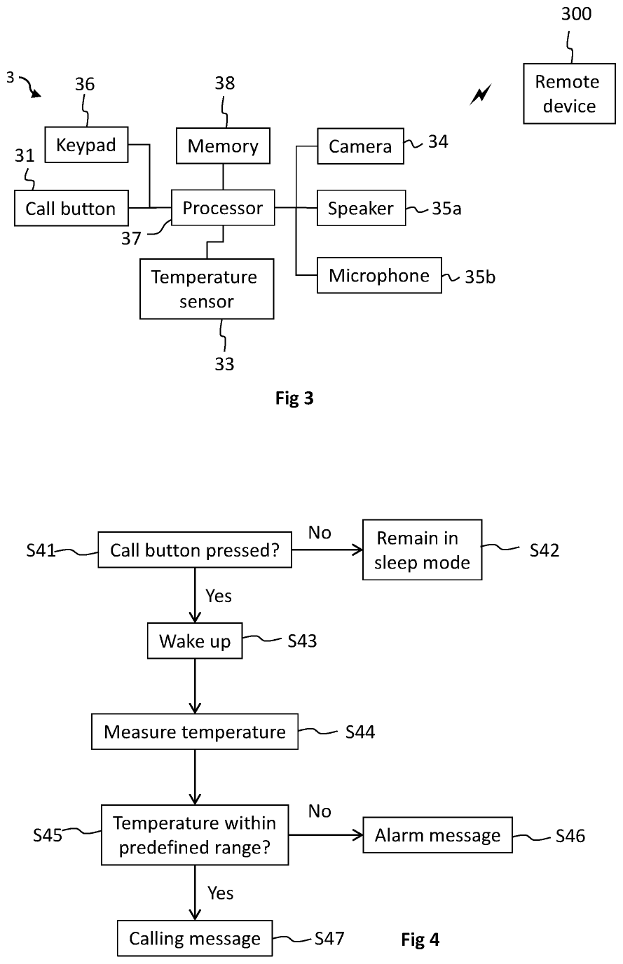

FIG. 3 shows a block diagram of a doorbell 3. Some of the below-described components of the doorbell 3 may be optional. The doorbell 3 may thus correspond to the doorbell 1 of FIG. 1 or the doorbell 2 of FIG. 2, or to an embodiment not shown in FIGS. 1 and 2. As shown in FIG. 3, a doorbell 3 comprises a call button 31 and a temperature sensor 33. These components are described above in connection to FIGS. 1 and 2. The positioning of the call button 31 and the temperature sensor 33 is also described above in connection to FIGS. 1 and 2.

The doorbell 3 may be in communication with a remote device 300. To this end, the doorbell 3 may be provided with a communication module (not shown). The communication module may enable a wired or wireless connection. In an embodiment, the remote device 300 is not part of the doorbell 3. The remote device 300 may communicate with the doorbell 3 using a wired connection or a wireless connection. The remote device 300 may be a remote server, a control panel, a gateway, a hand-held user device such as a mobile phone or a tablet, a user device such as a desktop computer, a digital assistant, or any other suitable device. The remote device 300 may be connected to the doorbell 3 via a network. The remote device 300 may be connected to the doorbell 3 via internet connection. For example, the remote device 300 may be connected to the doorbell 3 via a wireless or data network (of any suitable type such as mobile network, Wi-Fi, Bluetooth, ZigBee and the like). In some instances, the remote device 300 may be an indoor panel or a desktop computer, and the connection to the remote device may be via wired connection. In some instances, the remote device 300 may be a remote server which is in communication with a user device of a type described above (e.g. a mobile phone, a tablet or a digital assistant). In an embodiment, the remote device 300 is a gateway and the network is a wireless network. In an embodiment, the remote device 300 is a mobile phone and the network is a wireless network.

The doorbell 3 further comprises a processor 37, a memory 38 and a power source (not shown). The power source may be a battery. The memory 38 stores instructions for the processor 37 to execute one or more operations, for example as described below in connection with FIGS. 4 and 5. While the memory 38 is shown as a separate component in FIG. 3, it may be integrated in the processor 37.

The doorbell 3 may further comprise a camera 34, a speaker 35a, a microphone 35b, and a keypad 36. These components may be of any suitable type. These components are optional.

FIG. 4 shows an example operation of the doorbell 1, 2, 3. In the following, the operation of the doorbell 1, 2, 3 will be described with reference to the doorbell 3 of FIG. 3. It will be clear to the skilled person that this reference to FIG. 3 is non-limiting and that the operation would be the same with different embodiments of the doorbell 1, 2, 3. In the following, a user operating the doorbell 1, 2, 3 to request access to a building will be denoted ‘visitor’.

The doorbell 3, when not in use, may be in a sleep mode. This saves energy, and is advantageous especially when the doorbell 3 is powered by a battery. When the call button 31 is not pressed, the doorbell 3 enters sleep mode and stays in the sleep mode. For example, the call button 31 may enter sleep mode after a period of inactivity. This is shown in steps S41 and S42.

When the call button 31 is pressed, the doorbell 3 wakes up from sleep mode (steps S41 and S43). Upon waking up, the processor 37 of the doorbell 3 activates the temperature sensor 33, which measures the temperature of a user's wrist (step S44). The processor 37 then compares the temperature measured in step S44 with a range of temperatures or a temperature threshold stored in the memory 38 (step S45), and output the result of the comparison, e.g. that the temperature is within a range, that the temperature is above/below a threshold, and the like. A range of temperatures may be understood as an interval between an upper threshold and a lower threshold.

The temperature threshold or the upper threshold of a range may be for example 38° C. The threshold may be between 37.2° C. and 38.3° C. The threshold may be 38.5° C. It may be possible for a user of the doorbell 3 to set the threshold, e.g. using the remote device 300. The threshold may be set according to an agreed definition of fever in the given region.

The range of temperatures may use the above-described temperature threshold as the upper limit (upper threshold). The lower limit (lower threshold) may be set to e.g. 35° C.

If a visitor's temperature is within the predefined range or within the predefined threshold, the processor 37 may output a calling message (step S47). The calling message may draw an attention of a user with the right to grant access to the building to the visitor requesting access. An information about the visitor's temperature being within the predefined range or below the threshold may be included in the calling message. The calling message may be transmitted from the doorbell 3 to the remote device 300 over a network.

If a visitor's temperature is above the predefined threshold or not within the predefined range, the processor 38 may output an alarm message (step S46). The alarm message may draw an attention of a user with the right to grant access to the building to the visitor requesting access, and in addition, it may include an information about the visitor's temperature being above the predefined threshold or outside the predefined range. The alarm message may comprise an advice or a warning that admitting the visitor into the building is not advisable. The alarm message may be transmitted from the doorbell 3 to the remote device 300 over a network.

In some embodiments, if the visitor's temperature is below the lower limit (lower threshold) of the predefined range, the alarm message output by the processor 38 may draw the user's attention to the fact that the visitor's temperature is unlikely to have been measured correctly. In such case, the user may have to instruct the visitor to retake their temperature, e.g. by actuating the button 31 again. This may be done using the remote device 300, the speaker 35a, or any other suitable component.

FIG. 5 shows an example operation of the doorbell 1, 2, 3. In the following, the operation of the doorbell 1, 2, 3 will be described with reference to the doorbell 3 of FIG. 3. As discussed in connection to FIG. 4, it will be clear to the skilled person that this reference to FIG. 3 is non-limiting and that the operation would be the same with different embodiments of the doorbell 1, 2, 3. In the following, a user operating the doorbell 1, 2, 3 to request access to a building will be denoted ‘visitor’. It is to be understood that the steps described below in connection to FIG. 5 may complement or replace steps described above in connection to FIG. 4.

In an example operation, when the call button 31 is actuated by a visitor, it generates a call signal. The call signal is received by the processor 37 upon the call button 31 being actuated (step S51). If the doorbell 3 or any of its components (e.g. the temperature sensor 33) are in sleep mode, the call signal may initiate the doorbell and/or its components leaving the sleep mode. In particular, in response to the call signal, the processor 37 may command the temperature sensor 33 to wake up.

The processor 37 commands the temperature sensor 37 to measure temperature of the visitor's wrist (step S52), which in an embodiment is positioned above or adjacent to the temperature sensor 33, as described above in connection to FIGS. 1 and 2.

Upon receiving the measured temperature from the temperature sensor 33, the processor 37 compares the measured visitor's temperature to a predefined threshold or predefined range of temperatures stored within a memory 38 (step S53). The threshold or range may be the same as described above in connection to FIG. 4.

The result of the comparison is output and sent to a remote device 300 over the network (step S55). The result may be the same or similar to that described above in connection to FIG. 4. In particular, the calling message and the alarm message may be the same or similar in the operation of FIG. 5.

Other ways of operating the doorbell 3 are possible. For example, sleep mode may be omitted. In an embodiment, if a visitor's temperature measured by the temperature sensor 33 is below the lower limit (lower threshold) of a predefined range, the doorbell 3 may output a message for the visitor to actuate the call button 31 again; in such a case, the output message may comprise guidance for the user as to correct positioning of the visitor's hand and wrist (hand and lower arm) and/or removing any clothes form the visitor's wrist.

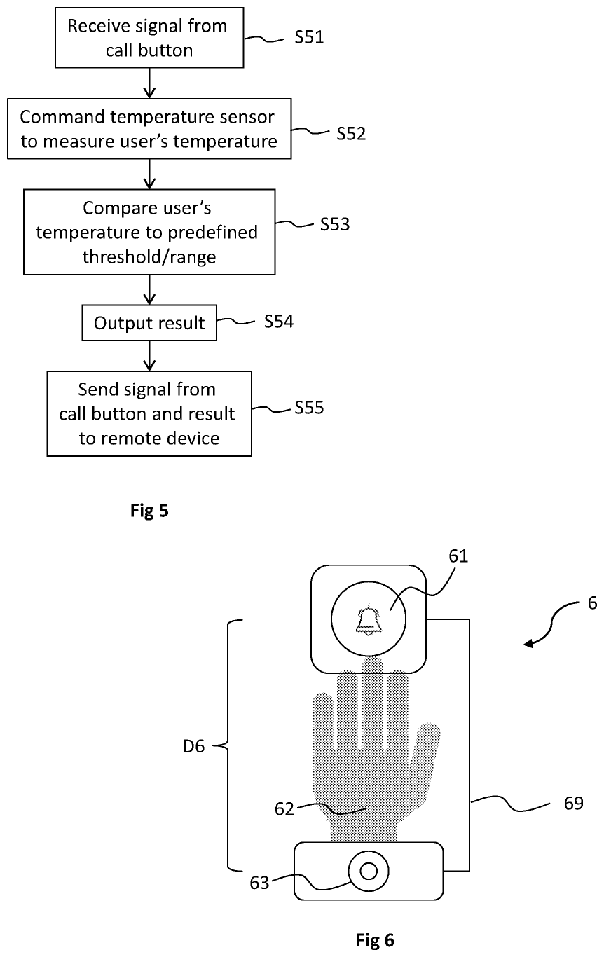

Other configurations of the doorbell are possible. For example, FIG. 6 shows an embodiment without a housing comprising the call button 61 and the temperature sensor 63. Instead, the call button 61 and the temperature sensor 63 are provided as two separate devices connected together by a connection 69. This embodiment may work in the same manner as described above in connection to FIGS. 1 to 5. The call button 61 and the temperature sensor 63 may be positioned in a distance D6 from each other; the distance D6 may correspond to distance D1, D2 described above.

1. A smart doorbell communicatively connectable to at least one remote device via a network, the smart doorbell comprising:
a processor;
a call button configured to output a first signal when the call button is actuated by a user; and
a temperature sensor positioned with respect to the call button such that when the call button is actuated by a user, the temperature sensor is capable of taking temperature measurements on a part of the user's wrist facing the temperature sensor;
wherein in response to the call button being actuated by a user, the processor is configured to:
receive the first signal from the call button;
command the temperature sensor to measure a temperature of a part of the user's wrist;
compare the temperature measured by the temperature sensor to a predefined threshold temperature;
output a second signal according to the comparison between the temperature measured by the temperature sensor and the predefined threshold; and
transmit the first signal and the second signal to at least one remote device via the network.

2. A smart doorbell of claim 1, wherein the second signal comprises information about the user's temperature measured by the temperature sensor being higher than the predefined threshold temperature.

3. A smart doorbell of claim 1, wherein the second signal comprises an authorization message permitting entrance of the user if the temperature is below or equal to the predefined threshold temperature.

4. A smart doorbell of claim 1, wherein the call button and the temperature sensor are separated by a distance of between 5 centimeters and 25 centimeters.

5. A smart doorbell of claim 1, wherein in use, the call button is positioned in the upper part of the doorbell and the temperature sensor is positioned in the lower part of the doorbell.

6. A smart doorbell of claim 1, wherein the second signal comprises information about the user's temperature measured by the temperature sensor being outside of a predefined range of temperatures.

7. A smart doorbell of claim 6, wherein the second signal comprises information about the user's temperature measured by the temperature sensor being below a predefined lower threshold of a range of temperatures.

8. A smart doorbell of claim 1, wherein the doorbell is configured to receive transmissions from the remote device.

9. A smart doorbell of claim 8, wherein the doorbell is configured to grant access to a user based on the transmission received from the remote device.

10. A method of operating a smart doorbell communicatively connectable to at least one remote device via a network, the doorbell comprising:
a processor;
a call button configured to output a first signal when the call button is actuated by a user; and
a temperature sensor positioned with respect to the call button such that when the call button is actuated by a user, the temperature sensor is capable of taking temperature measurements on a part of the user's wrist facing the temperature sensor; the method comprising the following steps executed by the processor:
receiving, in response to the call button being actuated by a user, the first signal from the call button;
commanding, in response to receiving the first signal, the temperature sensor to measure a temperature of a part of the user's wrist,
comparing the temperature of the part of the visitor's wrist to a predefined threshold temperature,
outputting a second signal according to the comparison between temperature measured by the temperature sensor and the predefined threshold, and
transmitting the first signal and the second signal to the at least one remote device via the network.

11. A method of claim 10, wherein the second signal comprises information about the user's temperature measured by the temperature sensor being higher than the predefined threshold temperature.

12. A method of claim 10, wherein the second signal comprises information about the user's temperature measured by the temperature sensor being outside of a predefined range of temperatures.

13. A method of claim 10, further comprising:
receiving a transmission from the at least one remote device.

14. A method of claim 13, further comprising:
granting, based on the transmission received from the user device, access to a user.

15. A method of claim 1, further comprising:
placing the doorbell at a location such that the call button is positioned in the upper part of the doorbell and the temperature sensor is positioned in the lower part of the doorbell.
